(19) United States
(12) Patent Application Publication
(10) Pub. No.: US 2002/0162923 A1
(43) Pub. Date: Nov. 7, 2002

(54) Support for a cooking vessel

(76) Inventor: Allen Geddes, Burton on Trent (GB)

Correspondence Address: Ray L. Weber, Renner, Kenner, Greive, Bobak, Taylor & Weber, 1610 First National Tower, Akron, OH, 44308-1456, US

(21) Appl. No.: 10/107,757

(22) Filed: Mar. 26, 2002

(30) Foreign Application Priority Data
Mar. 27, 2001 (GB) GB 0107566.2

(51) Int. Cl. A47J 37/10; F16M 11/00

(52) U.S. Cl. 248/176.1; 99/422

(57) ABSTRACT

A support 6 for a cooking vessel 11 comprises a ring having an upper portion 12, 13 for supporting the cooking vessel, and a lower portion 3 formed with L-shaped slots 2 for bayonet-type engagement with tines 10 of a pan support grid 7 of a conventional gas hob.

This invention relates to a support for a cooking vessel, and it has particular, but not exclusive, reference to a support for use with round bottomed vessels on a conventional gas hob or range.

Round-bottomed cooking vessels such as woks, karahis and baltis are becoming increasingly used in western kitchens in the preparation of oriental dishes, but conventional western gas hobs or ranges are ill-equipped to support such vessels in a stable manner, and there is accordingly a significant risk that hot oil or other food product may be spilled from the cooking vessel to scald someone close by.

It is a principal object of this invention to provide a simple and inexpensive means of reducing this risk.

According to this invention there is provided a support for a cooking vessel comprising a ring having an upper portion for supporting a said cooking vessel, and a lower portion formed with L-shaped slots for bayonet-type engagement with a gas hob grid.

The invention provides a simple and inexpensive means whereby a round-bottomed cooking vessel may be supported above a conventional gas hob or range.

The ring is suitably formed by bending a strip of sheet material into a circle and securing the ends of the strip together, for example by riveting, but it is preferred that the ring comprises a strip of sheet material whose ends are welded together, preferably butt-welded together. The adoption of these features promotes neatness of the support, and welding, especially butt-welding tends to promote an absence of crevices in which food particles may lodge, so being beneficial for hygiene.

The ring may be formed from any suitable heat resistant material, but it is preferably constituted by stainless steel or aluminium sheet.

In preferred embodiments of the invention, tongues formed between the L-shaped slots and a lower edge of the support ring increase in breadth away from their ends. This allows a tolerance in sizes of hob grids with which the support may interengage, and it further provides a means of ensuring the possibility of a secure interengagement.

Advantageously, an upper edge of the ring is provided with protrusions for supporting a said cooking vessel, and preferably, as an alternative, or in addition, said ring comprises cut-outs affording gas-flow passages. The provision of such gas flow passages, whether through the body of the support or between protrusions on its upper edge promotes a proper combustion of the cooking gas, and a desirable heating of the cooking vessel.

In some preferred embodiments of the invention, the ring is generally frusto-conical in shape, the lower portion being of lesser diameter than the upper. This affords a usefully wide support for the cooking vessel.

In other preferred embodiments of the invention, the ring is generally cylindrical in shape. Reference has so far been made exclusively to the use of the support with a round-bottomed cooking vessel. The use of a generally cylindrical support ring of appropriate size has advantages in conjunction with flat-bottomed cooking vessels such as saucepans. By selecting such a support ring of a size that it surrounds a saucepan fairly closely, protection is afforded against that saucepan being accidentally knocked off the hob or range or being otherwise spilled.

Preferred embodiments of the invention will now be described with reference to the accompanying diagrammatic drawings in which:

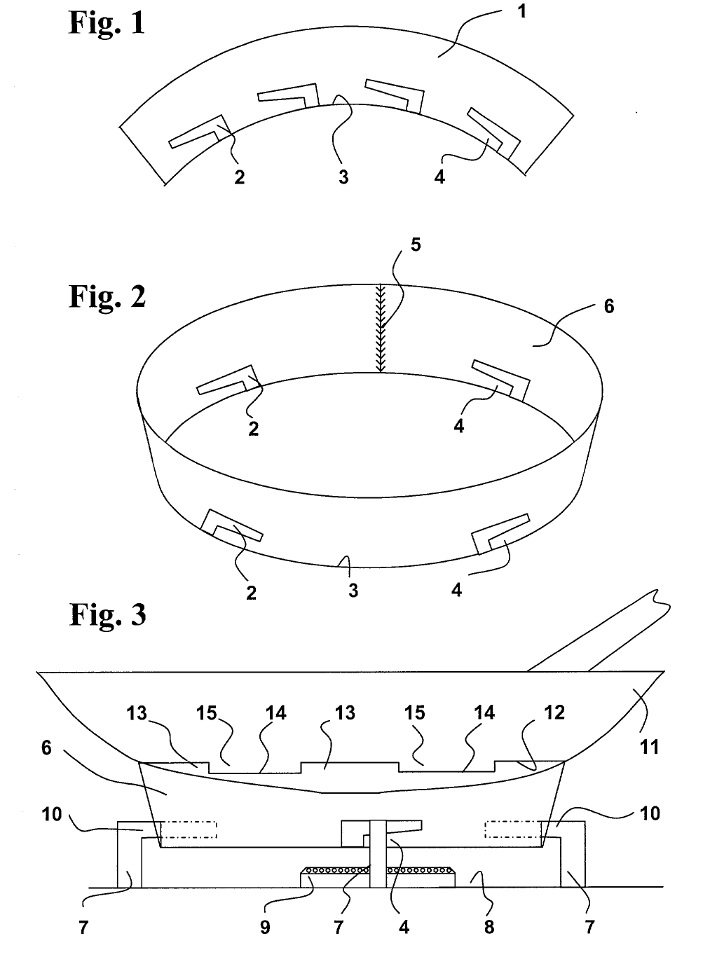

FIG. 1 is a view of a metal strip for forming a support for a cooking vessel in accordance with a first embodiment of the invention;

FIG. 2 is a perspective view of the support made up from the strip of FIG. 1;

FIG. 3 is an elevational view of a second embodiment of the invention; and

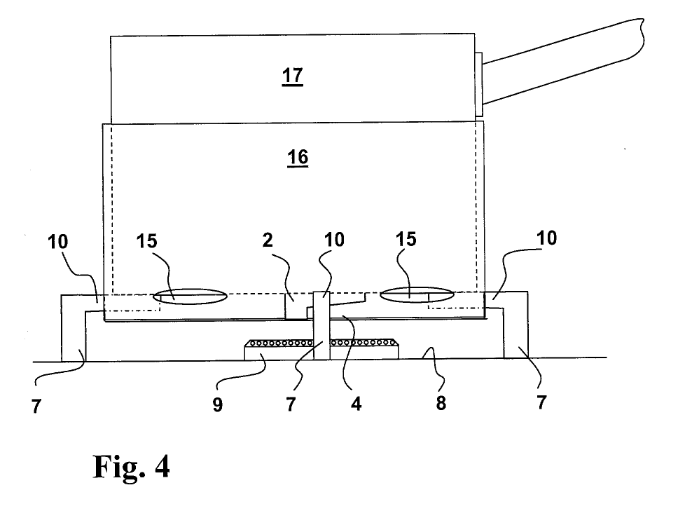

FIG. 4 is an elevational view of a third embodiment of the invention.

In FIG. 1, an arcuate strip of metal 1 has a series of L-shaped slots 2 punched out from its lower margin 3 to leave tongues of metal 4 which as shown increase in breadth from their ends. FIG. 2 shows the ends of the strip 1 of FIG. 1 bent round and butt-welded together at 5 to form a support 6 in accordance with the invention. Because of the arcuate shape of the strip 1, the resulting support ring 6 is frusto-conical in shape. Compare also FIG. 3.

FIG. 3 shows an embodiment of support ring 6 secured to a pan support grid 7 of a conventional gas hob or range 8 incorporating a burner 9. Four L-shaped slots 2 of the support ring 6 respectively engage tines 10 of the pan support grid 7 to form a bayonet-type interengagement which is made the more secure by urging the ring 6 clockwise so that the increasing breadth of the tongues 4 engaging under the tines 10 progressively tightens the ring 6 onto the grid 7.

A wok 11 or other round-bottomed cooking vessel is shown supported by the upper margin 12 of the support ring 6. As shown, that upper margin 12 is provided with protrusions 13 in the form of merlons with embrasures 14 therebetween which together with the base of the cooking vessel 11 define gas flow passages 15. Such an arrangement allows air to be drawn in under the support ring 6 so that combustion products of that air and gas from the burner 9 can circulate beneath the cooking vessel 11 in a manner conducive to efficient heating of that vessel.

FIG. 4 shows a modified form of support ring 16 which is generally cylindrical in shape. This embodiment of support ring 16 is secured to the tine of a pan support grid 7 by a bayonet type arrangement as described with reference to FIG. 3, and like reference numerals are allotted in FIG. 4. The support ring 16 is selected as being a fairly close fit around a conventional saucepan 17 also of cylindrical form which rests of the tines 10 of the pan support grid 7. It will be appreciated that such a close fit is not essential, but that the closer the fit, the more difficult it will be to remove the saucepan from the heat other than vertically. This makes it difficult accidentally to dislodge the saucepan from the hob. The support ring 16 incorporates holes defining gas flow passages 15 at the level of the inner boundary of the slots 2, that is at the level of the base of the saucepan 17.

1. A support for a cooking vessel comprising a ring having an upper portion for supporting a said cooking vessel, and a lower portion formed with L-shaped slots for bayonet-type engagement with a gas hob.

2. A support according to claim 1, wherein the ring comprises a strip of sheet material whose ends are welded together.

3. A support according to claim 2, wherein the ends of the strip of sheet material are butt-welded together.

4. A support according to claim 1, wherein the ring is constituted by stainless steel or aluminium sheet.

5. A support according to claim 1, wherein tongues formed between the L-shaped slots and a lower edge of the support ring increase in breadth away from their ends.

6. A support according to claim 1, wherein an upper edge of the ring is provided with protrusions for supporting a said cooking vessel.

7. A support according to claim 1, wherein said ring comprises cut-outs affording gas-flow passages.

8. A support according to claim 1, wherein the ring is generally frusto-conical in shape, the lower portion being of lesser diameter than the upper.

9. A support according to claim 1, wherein the ring is generally cylindrical in shape.

10. A gas hob equipped with a support for a cooking vessel according to claim 1.
